(19) United States
(12) Patent Application Publication
(10) Pub. No.: US 2026/0208065 A1
(43) Pub. Date: Jul. 23, 2026

(54) SYSTEM AND METHOD FOR ENHANCED VAPOR AND LIQUID DISTRIBUTION

(71) Applicant: CALGON CARBON CORPORATION, Moon Township, PA (US)

(72) Inventors: George MEJALLI, South Park, PA (US); Jeremy WILFONG, Monaca, PA (US)

(73) Assignee: CALGON CARBON CORPORATION, Moon Township, PA (US)

(21) Appl. No.: 19/456,560

(22) Filed: Jan. 22, 2026

Related U.S. Application Data
(60) Provisional application No. 63/748,226, filed on Jan. 22, 2025.

(51) Int. Cl. B01D 3/00; B01D 15/00; B01D 53/04

(52) U.S. Cl. CPC B01D 3/008; B01D 15/00; B01D 53/0446

(57) ABSTRACT

Systems and methods for the distribution of fluids are described herein. The systems include a distributor having multiple arms with holes to distribute fluid. The holes are arranged in a spiral pattern on each of the multiple arms to allow for an even distribution of fluid from each of the arms.

### CROSS-REFERENCE TO RELATED APPLICATIONS

This application claims benefit of and priority to U.S. Provisional Patent Application No. 63/748,226 titled “SYSTEM AND METHOD FOR ENHANCED VAPOR AND LIQUID DISTRIBUTION” filed Jan. 22, 2025, the disclosure of which is incorporated by reference herein in its entirety.

### BACKGROUND

Solid sorbent media, such as granular activated carbon (GAC), are used for various filtration applications (e.g., for filtering water, air, or liquid chemicals). In such filtration applications the solid sorbent media are contained within a vessel through which fluid is designed to flow across the sorbent media during operation. In this process, chemical compounds are concentrated on the sorbent media until the media's sorbent capacity has been reached, at which point the spent, that is, saturated, sorbent media must be replaced with new media that has capacity for the chemical compounds.

Sorbent vessels are widely used in industrial and environmental applications for fluid treatment, purification, and separation processes. These vessels typically contain adsorbent materials such as activated carbon, zeolites, or other specialized media that can selectively remove contaminants or specific compounds from liquids or gases passing through them. The efficiency and effectiveness of sorbent vessels largely depend on the uniform distribution of the fluid throughout the sorbent bed.

Conventional fluid distribution systems in sorbent vessels often face challenges in achieving optimal performance. Conventional fluid distribution systems include outlet holes positioned in straight rows along the length of pipes. Such systems are designed with a small outlet hole area relative to the pipe diameter to improve distribution flow through each outlet hole. However, these designs inherently provide numerous problems detrimental to the performance of the distributor. One common issue is a high pressure drop across the distribution system, which can lead to increased energy consumption and operational costs. This problem is particularly pronounced in large-scale industrial applications where maintaining low pressure drops is crucial for process efficiency.

Another significant challenge is high outlet velocity from the distribution system. When fluid exits the distributor at high velocities, it can cause localized channeling within the adsorbent bed. When channeling is localized instead of evenly spread across the sorbent bed, different portions of sorbent will become saturated at different rates. This phenomenon can result in reduced treatment capacity and an increased requirement for the exchange of the sorbent material or the backwashing of the sorbent material. Uneven flow distribution is a persistent problem in many sorbent vessel designs. Inadequate fluid distribution can create preferential flow paths through the adsorbent bed, leaving portions of the adsorbent material underutilized. This non-uniform contact between the fluid and the adsorbent material can significantly reduce the overall efficiency of the treatment process and lead to premature breakthrough of contaminants. Breakthrough occurs when contaminated water escapes or “breaks through” the sorbent bed to be discharged as effluent.

There exists a need for improvements in distribution systems that can minimize pressure drop, reduce outlet velocities, and promote even flow distribution to enhance the performance and efficiency of sorbent vessels.

### SUMMARY

In one embodiment, a distributor for a sorbent vessel includes a main pipe configured to supply a fluid to the distributor; and a plurality of arms operably connected to the main pipe and configured to supply the fluid to the sorbent vessel, wherein each of the plurality of arms includes a series of holes arranged in a spiral pattern.

In some embodiments, the distributor has a pressure drop measured from the main pipe to the plurality of arms of about 0.25 psi to about 0.40 psi at a flow rate of 1000 gallons per minute.

In some embodiments, the distributor has a pressure drop measured from the main pipe to the plurality of arms of about 0.30 psi to about 0.35 psi at a flow rate of 1000 gallons per minute.

In some embodiments, each of the holes is substantially the same size.

In some embodiments, the holes increase in diameter along a length of each of the plurality of arms.

In some embodiments, the holes decrease in diameter along a length of each of the plurality of arms.

In some embodiments, each of the holes has a diameter of about 0.1 inches to about 2 inches.

In some embodiments, each of the holes has a diameter of about 0.5 inches to about 1 inch.

In some embodiments, each of the holes arranged in a spiral pattern have a ratio of a spiral pitch to a hole size of about 2.0 to about 8.0.

In some embodiments, the plurality of arms includes 2, 3, 4, 5, 6, 7, or 8 arms.

In some embodiments, a spiral pitch of the spiral pattern is substantially the same along a length of an arm.

In some embodiments, a spiral pitch of the spiral pattern increases along a length of an arm.

In some embodiments, a spiral pitch of the spiral pattern decreases along a length of an arm.

In some embodiments, the distributor has a pressure drop ratio of about 4.0 to about 8.0.

In one embodiment, a method of filtering chemical compounds from a fluid includes providing a sorbent vessel having a sorbent material within the sorbent vessel; providing a distributor having a main pipe configured to supply a fluid to the distributor and having a plurality of arms operably connected to the main pipe and configured to supply the fluid to the sorbent vessel, and distributing the fluid to the sorbent vessel using the distributor, wherein each of the plurality of arms includes a series of holes arranged in a spiral pattern.

In some embodiments, the distributor has a pressure drop measured from the main pipe to the plurality of arms of about 0.25 psi to about 0.40 psi at a flow rate of 1000 gallons per minute.

In some embodiments, the distributor has a pressure drop measured from the main pipe to the plurality of arms of about 0.30 psi to about 0.35 psi at a flow rate of 1000 gallons per minute.

In some embodiments, each of the holes is substantially the same size.

In some embodiments, the holes increase in diameter along a length of each of the plurality of arms.

In some embodiments, the holes decrease in diameter along a length of each of the plurality of arms.

In some embodiments, each of the holes has a diameter of about 0.1 inches to about 2 inches.

In some embodiments, each of the holes has a diameter of about 0.5 inches to about 1 inch.

In some embodiments, each of the holes arranged in a spiral pattern have a ratio of a spiral pitch to a hole size of about 2.0 to about 8.0.

In some embodiments, the plurality of arms includes 2, 3, 4, 5, 6, 7, or 8 arms.

In some embodiments, a spiral pitch of the spiral pattern is substantially the same along a length of an arm.

In some embodiments, a spiral pitch of the spiral pattern increases along a length of an arm.

In some embodiments, a spiral pitch of the spiral pattern decreases along a length of an arm.

In some embodiments, the fluid is distributed at a velocity ratio of about 2.0 to about 8.0.

### BRIEF DESCRIPTION OF DRAWINGS

FIG. 1 depicts an illustrative prior art fluid distributor.

FIG. 2 depicts an illustrative fluid distributor in accordance with an embodiment.

FIG. 3 depicts an illustrative fluid distributor arm in accordance with an embodiment.

FIG. 4 depicts an illustrative sorbent vessel having a fluid distributor in accordance with an embodiment.

FIG. 5 depicts a flow chart of an illustrative method of filtering chemical compounds from a fluid in accordance with an embodiment.

FIGS. 6, 7A, and 7B depict experimental representations of fluid flow through fluid distributors in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

As used herein, the term “sorbent material” is meant to encompass all known materials from any source that are capable of absorbing or adsorbing liquids and/or gases. For example, sorbent materials include, but are not limited to, activated carbon, reactivated carbon, natural and synthetic zeolite, silica, silica gel, alumina, zirconia, and diatomaceous earths.

The scope of the present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

### DETAILED DESCRIPTION

This disclosure is not limited to the particular systems, devices, and methods described, as these may vary. The terminology used in the description is for the purpose of describing the particular versions or embodiments only and is not intended to limit the scope.

### Products

Distributors may be assembled for enhanced fluid distribution in sorbent vessels. In some embodiments, a distributor may comprise a main pipe configured to supply fluid to a plurality of arms operably connected to the main pipe. Each of the multiple arms may include a series of holes arranged in a spiral pattern. The spiral arrangement of holes allows for improved distribution of fluid from the arms to a sorbent vessel and a more uniform fluid diffusion as compared to conventional distribution devices. The spiral hole arrangement of the distributor arms may result in decreased fluid velocity and pressure drop compared to traditional distributor designs.

FIG. 1 depicts a prior art distributor for supplying fluid to a sorbent vessel. The distributor comprises a main pipe 101 operably connected to a plurality of arms 102 and configured to supply a fluid to each of the plurality of arms 102. Each of the plurality of arms 102 comprise a series of holes 103 configured to distribute the fluid from the distributor to the sorbent vessel. The series of holes 103 in the prior art distributor are arranged in a linear pattern throughout the length of each of the plurality of arms 102. The linear pattern leads to an increased pressure drop and an uneven distribution of the fluid into the sorbent vessel.

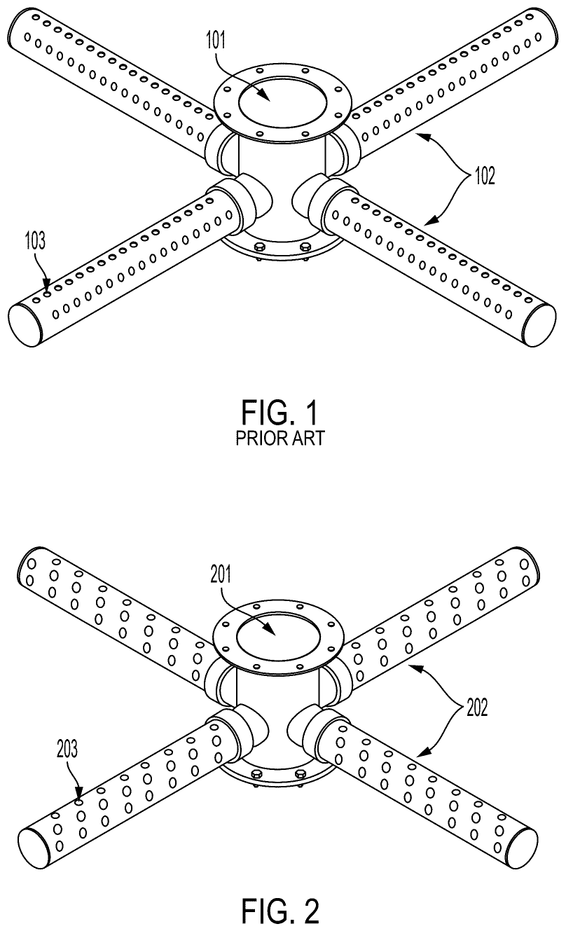

FIG. 2 depicts an illustrative distributor for supplying fluid to a sorbent vessel in accordance with an embodiment. The distributor comprises a main pipe 201 operably connected to a plurality of arms 202 and configured to supply a fluid to each of the plurality of arms 202. Each of the plurality of arms 202 comprises a series of holes 203 configured to supply fluid from the distributor to the sorbent vessel. The series of holes 203 on each of the plurality of arms 202 is arranged in a spiral pattern. The spiral pattern allows for an improved distribution of fluid from the plurality of arms 202 to a sorbent vessel and a more uniform fluid diffusion as compared to the arms 102 in the prior art distributor. The spiral pattern provides the additional benefits of a decreased pressure drop as compared to the prior art design. Each of the series of holes comprises a spiral pattern over substantially the entire length of each of the plurality of arms 202.

The distributor may comprise any number of arms 202 effective for the distribution of a fluid from the distributor. In some embodiments, the distributor comprises 2, 3, 4, 5, 6, 7, or 8 arms 202. In some embodiments, the plurality of arms 202 are substantially uniformly distributed around the main pipe 201. Each of the arms 202 may have any length effective for the distribution of the fluid from the distributor. In some embodiments, each of the arms 202 has a length of about 6 inches, about 12 inches, about 18 inches, about 24 inches, about 30 inches, about 36 inches, about 42 inches, about 48 inches, or any value or range of values between any two of these values. Each of the arms 202 may have any diameter effective for the distribution of the fluid from the distributor. In some embodiments, each of the arms 202 has a diameter of about 2.0 inches, about 2.1 inches, about 2.2 inches, about 2.3 inches, about 2.4 inches, about 2.5 inches, about 2.6 inches, about 2.7 inches, about 2.8 inches, about 2.9 inches, about 3.0 inches, about 3.1 inches, about 3.2 inches, about 3.3 inches, about 3.4 inches, about 3.5 inches, about 3.6 inches, about 3.7 inches, about 3.8 inches, about 3.9 inches, about 4.0 inches, about 4.1 inches, about 4.2 inches, about 4.3 inches, about 4.4 inches, about 4.5 inches, about 4.6 inches, about 4.7 inches, about 4.8 inches, about 4.9 inches, about 5.0 inches, about 5.1 inches, about 5.2 inches, about 5.3 inches, about 5.4 inches, about 5.5 inches, about 5.6 inches, about 5.7 inches, about 5.8 inches, about 5.9 inches, about 6.0 inches, about 6.1 inches, about 6.2 inches, about 6.3 inches, about 6.4 inches, about 6.5 inches, about 6.6 inches, about 6.7 inches, about 6.8 inches, about 6.9 inches, about 7.0 inches, about 7.1 inches, about 7.2 inches, about 7.3 inches, about 7.4 inches, about 7.5 inches, about 7.6 inches, about 7.7 inches, about 7.8 inches, about 7.9 inches, about 8.0 inches, about 8.1 inches, about 8.2 inches, about 8.3 inches, about 8.4 inches, about 8.5 inches, about 8.6 inches, about 8.7 inches, about 8.8 inches, about 8.9 inches, about 9.0 inches, about 9.1 inches, about 9.2 inches, about 9.3 inches, about 9.4 inches, about 9.5 inches, about 9.6 inches, about 9.7 inches, about 9.8 inches, about 9.9 inches, about 10.0 inches, about 10.1 inches, about 10.2 inches, about 10.3 inches, about 10.4 inches, about 10.5 inches, about 10.6 inches, about 10.7 inches, about 10.8 inches, about 10.9 inches, about 11.0 inches, about 11.1 inches, about 11.2 inches, about 11.3 inches, about 11.4 inches, about 11.5 inches, about 11.6 inches, about 11.7 inches, about 11.8 inches, about 11.9 inches, about 12.0 inches, or any value or range of values between any two of these values.

The use of the spiral pattern for each of the series of holes results in a decreased pressure drop as compared to conventional distributors. In some embodiments, the distributor has a pressure drop at a flow rate of 1000 gallons per minute measured from the main pipe 201 to the plurality of arms 202 of about 0.20 psi, about 0.21 psi, about 0.22 psi, about 0.23 psi, about 0.24 psi, about 0.25 psi, about 0.26 psi, about 0.27 psi, about 0.28 psi, about 0.29 psi, about 0.30 psi, about 0.31 psi, about 0.32 psi, about 0.33 psi, about 0.34 psi, about 0.35 psi, about 0.36 psi, about 0.37 psi, about 0.38 psi, about 0.39 psi, about 0.40 psi, about 0.41 psi, about 0.42 psi, about 0.43 psi, about 0.44 psi, about 0.45 psi, about 0.46 psi, about 0.47 psi, about 0.48 psi, about 0.49 psi, about 0.50 psi, about 0.51 psi, about 0.52 psi, about 0.53 psi, about 0.54 psi, about 0.55 psi, about 0.56 psi, about 0.57 psi, about 0.58 psi, about 0.59 psi, about 0.60 psi, or any value or range of values between any two of these values.

The spiral arrangement of holes allows for improved pressure drop as compared to conventional distribution devices having holes arranged in straight rows. In some embodiments, the spiral arrangement of holes allows for an improved ratio of the pressure drop measured from the main pipe 201 to the plurality of arms 202 and the fluid flow rate within the sorbent vessel, from the arms to a sorbent vessel and a more uniform fluid diffusion as compared to conventional distribution devices. In some embodiments, a pressure drop ratio of the distributor be determined using Equation 1 below.

Pressure Drop Ratio=(sqrt(Pressure Drop)/Flow Rate)*10000 Equation 1:

A lower pressure ratio provides an improved energy efficiency of the distributor. In some embodiments, the distributor may have a pressure drop ratio of about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0 or any value or range of values between any two of these values. In some embodiments, the distributor may have a pressure drop ratio of about 4.0 to about 8.0.

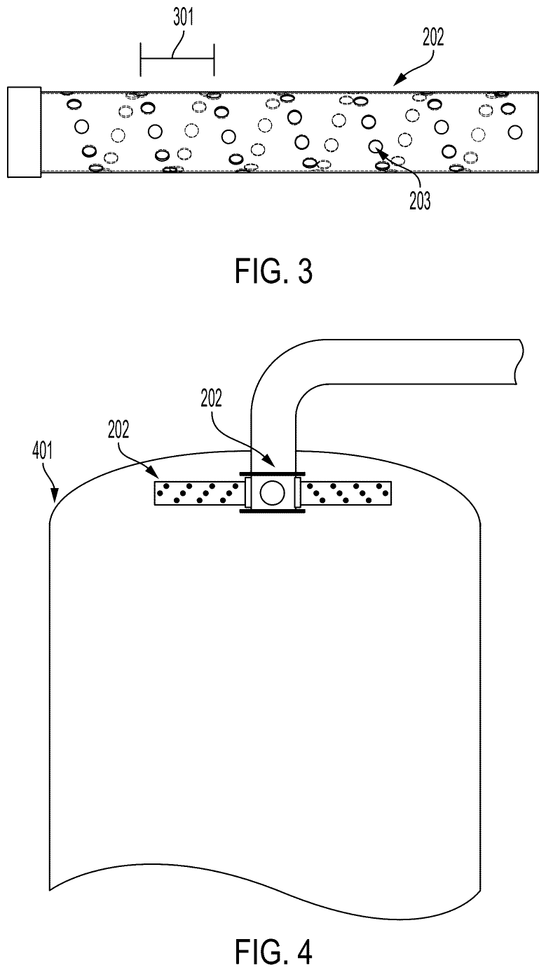

FIG. 3 depicts an illustrative arm 202 for a distributor. Each of the series of holes 203 may have a diameter of any size effective for the distribution of fluid from the distributor. In some embodiments, each of the holes 203 has a diameter of about 0.1 inches, about 0.2 inches, about 0.3 inches, about 0.4 inches, about 0.5 inches, about 0.6 inches, about 0.7 inches, about 0.8 inches, about 0.9 inches, about 1.0 inch, about 1.1 inches, about 1.2 inches, about 1.3 inches, about 1.4 inches, about 1.5 inches, about 1.6 inches, about 1.7 inches, about 1.8 inches, about 1.9 inches, about 2.0 inches, about 2.1 inches, about 2.2 inches, about 2.3 inches, about 2.4 inches, about 2.5 inches, about 2.6 inches, about 2.7 inches, about 2.8 inches, about 2.9 inches, about 3.0 inches, about 3.1 inches, about 3.2 inches, about 3.3 inches, about 3.4 inches, about 3.5 inches, about 3.6 inches, about 3.7 inches, about 3.8 inches, about 3.9 inches, about 4.0 inches, or any value or range of values between any two of these values. In some embodiments, each of the holes 203 has a diameter of about 0.1 inches to about 2 inches. In some embodiments, each of the holes 203 has a diameter of about 0.5 inches to about 1 inch.

In some embodiments, the diameter of each of the holes 203 is selected based on the diameter of the arm 202. For example, the diameter of each of the holes 203 may be selected based on a ratio between the diameter of the arm 202 and the diameter of each of the holes 203. In some embodiments, the ratio between the diameter of the arm 202 and the diameter of each of the holes 203 is about 50, about 45, about 40, about 35, about 30, about 25, about 20, about 19, about 18, about 17, about 16, about 15, about 14, about 13, about 12, about 11, about 10, about 9, about 8, about 7, about 6, about 5, or any value or range of values between any two of these values. In some embodiments, the diameter of each of the holes 203 is substantially the same over the length of the plurality of arms 202. In some embodiments, the diameter of the holes 203 on an arm 202 increases based on the distance of each hole from the main pipe 201. In some embodiments, the diameter of the holes 203 decreases based on the distance of each hole from the main pipe 201.

Each of the plurality of arms 202 may comprise any concentration of holes 203 effective for the distribution of the fluid from the distributor. In some embodiments, each of the series of holes is present in an amount of about 0.1 holes/in², about 0.2 holes/in², about 0.3 holes/in², about 0.4 holes/in², about 0.5 holes/in², about 0.6 holes/in², about 0.7 holes/in², about 0.8 holes/in², about 0.9 holes/in², about 1.0 hole/in², about 1.1 holes/in², about 1.2 holes/in², about 1.3 holes/in², about 1.4 holes/in², about 1.5 holes/in², about 1.6 holes/in², about 1.7 holes/in², about 1.8 holes/in², about 1.9 holes/in², about 2.0 holes/in², about 2.1 holes/in², about 2.2 holes/in², about 2.3 holes/in², about 2.4 holes/in², about 2.5 holes/in², about 2.6 holes/in², about 2.7 holes/in², about 2.8 holes/in², about 2.9 holes/in², about 3.0 holes/in², or any value or range of values between any two of these values.

The spiral pattern for each of the series of holes may have any spiral pitch 301 effective for the distribution of the fluid from the distributor. In some embodiments, the spiral pattern for each of the series of holes has a spiral pitch 301 of about 1 inch, about 1.5 inches, about 2 inches, about 2.5 inches, about 3.0 inches, about 3.5 inches, about 4.0 inches, about 4.5 inches, about 5.0 inches, about 5.5 inches, about 6.0 inches, or any value or range of values between any two of these values. In some embodiment, the spiral pitch 301 is selected based on the length of the arm 202. In some embodiments, the ratio of the length of the arm 202 to the spiral pitch 301 is about 50, about 45, about 40, about 35, about 30, about 25, about 20, about 19, about 18, about 17, about 16, about 15, about 14, about 13, about 12, about 11, about 10, about 9, about 8, about 7, about 6, about 5, or any value or range of values between any two of these values. In some embodiments, the spiral pattern has substantially the same pitch 301 over the length of an arm 202. In some embodiments, the pitch 301 of the spiral pattern increases over the length of the arm 202. In some embodiments, the pitch 301 of the spiral pattern decreases over the length of the arm 202.

In some embodiment, the spiral pitch 301 is selected based on the size of the holes 203. In some embodiments, the ratio of the spiral pitch 301 to the hole 203 size is about 2, about 2.5, about 3, about 3.5, about 4, about 4.5, about 5, about 5.5, about 6, about 6.5, about 7, about 7.5, about 8, or any value or range of values between any two of these values. In some embodiments, the ratio of the spiral pitch 301 to the holes 203 size is about 2 to about 8.

FIG. 4 depicts an illustrative sorbent vessel 401 comprising a distributor configured to provide a fluid to the sorbent vessel 401. The distributor may be positioned at any location within the sorbent vessel effective to provide an even distribution of fluid to the sorbent vessel. In some embodiments, the distributor is positioned near the top of the sorbent vessel. In some embodiments, the distributor is centered within the sorbent vessel.

The spiral arrangement of holes allows for improved distribution of fluid from the arms to the sorbent vessel 401 and a more uniform fluid velocity as compared to conventional distribution devices having holes arranged in straight rows. In some embodiments, the spiral arrangement of holes allows for an improved ratio of the maximum fluid velocity and a minimum fluid velocity within the sorbent vessel 401, from the arms to a sorbent vessel and a more uniform fluid diffusion as compared to conventional distribution devices. In some embodiments, a velocity ratio of the maximum fluid velocity and a minimum fluid velocity within the sorbent vessel 401 may be determined using Equation 2 below.

Velocity Ratio=(Max Velocity/Min Velocity)/Outlet Area Equation 2:

A lower velocity ratio provides a more uniform distribution of the fluid within the sorbent vessel 401 and a more uniform utilization of the sorbent material. In some embodiments, the distributor may have a velocity ratio of about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0 or any value or range of values between any two of these values. In some embodiments, the distributor may have a velocity ratio of about 2.0 to about 8.0.

### Methods

Methods may be performed to filter chemical compounds from a fluid using the above-described distributors.

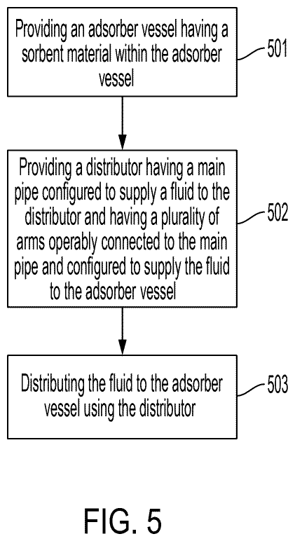

FIG. 5 depicts a diagram of an illustrative method of filtering chemical compounds from a fluid in accordance with an embodiment. The method comprises providing 501 a sorbent vessel having a sorbent material within the sorbent vessel. The sorbent material may be any sorbent material effective for the removal of chemicals from fluids known to one of skill in the art. In some embodiments, the sorbent material comprises one or more of carbonaceous char, activated carbon, reactivated carbon, carbon black, natural zeolite, synthetic zeolite, silica, silica gel, alumina, alumina clay, zirconia, diatomaceous earths, and metal oxides.

The method may further comprise providing 502 a distributor having a main pipe configured to supply a fluid to the distributor and having a plurality of arms operably connected to the main pipe and configured to supply the fluid to the sorbent vessel. In some embodiments, each of the plurality of arms comprises a series of holes arranged in a spiral pattern. In some embodiments, the distributor is positioned near the top of the sorbent vessel. In some embodiments, the distributor is centered within the sorbent vessel.

The method may further comprise distributing 503 fluid to the sorbent vessel using the distributor. In some embodiments, the chemical compound comprises perfluoroalkyl and polyfluoroalkyl substances (PFAS). In some embodiments, the fluid comprises one or more chemical compounds, and the sorbent material is configured to adsorb the chemical compounds from the fluid. The fluid may be distributed 503 to the adsorber at any flow rate effective for achieving a substantially even distribution of the fluid through the plurality of arms. In some embodiments, the fluid is distributed at a flow rate of about 50 gallons per minute (gpm), about 100 gpm, about 150 gpm, about 200 gpm, about 250 gpm, about 300 gpm, about 350 gpm, about 400 gpm, about 450 gpm, about 500 gpm, about 550 gpm, about 600 gpm, about 650 gpm, about 700 gpm, about 750 gpm, about 800 gpm, about 850 gpm, about 900 gpm, about 950 gpm, about 1,000 gpm, about 1,050 gpm, about 1,100 gpm, about 1,150 gpm, about 1,200 gpm, about 1,250 gpm, about 1,300 gpm, about 1,350 gpm, about 1,400 gpm, about 1,450 gpm, about 1,500 gpm, 1,600 gpm, about 1,700 gpm, about 1,800 gpm, about 1,900 gpm, about 2,000 gpm, about 2,100 gpm, about 2,200 gpm, about 2,300 gpm, about 2,400 gpm, about 2,500 gpm, about 2,600 gpm, about 2,700 gpm, about 2,800 gpm, about 2900 gpm, about 3,000 gpm, about 3,100 gpm, about 3,200 gpm, about 3,300 gpm, about 3,400 gpm, about 3,500 gpm, about 3,600 gpm, about 3,700 gpm, about 3,800 gpm, about 3,900 gpm, about 4,000 gpm, about 4,100 gpm, about 4,200 gpm, about 4,300 gpm, about 4,400 gpm, about 4,500 gpm, about 4,600 gpm, about 4,700 gpm, about 4,800 gpm, about 4,900 gpm, about 5,000 gpm or any value or range of values between any two of these values.

The use of arms having a series of holes arranged in a spiral pattern provides a low pressure drop for the distributor. In some embodiments, the distributor has a pressure drop measured from the pipe to the plurality of arms and at a flow rate of 1000 gallons per minute of about 0.20 psi, about 0.21 psi, about psi, about 0.22 psi, about 0.23 psi, about 0.24 psi, about 0.25 psi, about 0.26 psi, about 0.27 psi, about 0.28 psi, about 0.29 psi, about 0.30 psi, about 0.31 psi, about 0.32 psi, about 0.33 psi, about 0.34 psi, about 0.35 psi, about 0.36 psi, about 0.37 psi, about 0.38 psi, about 0.39 psi, about 0.40 psi, or any value or range of values between any two of these values.

In some embodiments, the use of arms having a series of holes arranged in a spiral pattern reduces a range for a fluid particle bed velocity as compared to conventional distributors. In some embodiments, the distributor has a range of fluid particle bed velocity measured from the pipe to the plurality of arms and at a flow rate of 1000 gallons per minute of about 1 foot per minute (fpm), about 2 fpm, about 3 fpm, about 4 fpm, about 5 fpm, about 6 fpm, about 7 fpm, about 8 fpm, or any range of values between any two of these values, such as about 1 fpm to about 8 fpm, about 1 fpm to about 7 fpm, about 1 fpm to about 6 fpm, about 1 fpm to about 5 fpm, about 2 fpm to about 8 fpm, about 2 fpm to about 7 fpm, about 2 fpm to about 6 fpm, about 2 fpm to about 5 fpm, about 3 fpm to about 8 fpm, about 3 fpm to about 7 fpm, about 3 fpm to about 6 fpm, or about 3 fpm to about 5 fpm.

### EXAMPLES

### Example 1: Fluid Flow Velocity at 1000 gpm

Computational fluid dynamics (CFD) software was used to simulate the fluid flow distribution and fluid flow velocity of water through a comparative conventional distributor and a sample distributor comprising holes arranged in a spiral pattern in a sorbent vessel. The comparative distributor comprised 4 arms each having holes of 0.5 inch diameter arranged in 3 rows with a spacing of 1.5 inches between each of the holes. The sample distributor comprises 4 arms each having holes of 0.75 inch diameter arranged in a spiral pattern with a pitch of 4 inches and a spacing of 1.5 inches between each of the holes. The arms for each of the comparative distributor and the sample distributor had a length of 30 inches. The sorbent vessel comprised a diameter of 12 feet. Each of the distributors was separately positioned near the top of the vessel and centered within the vessel.

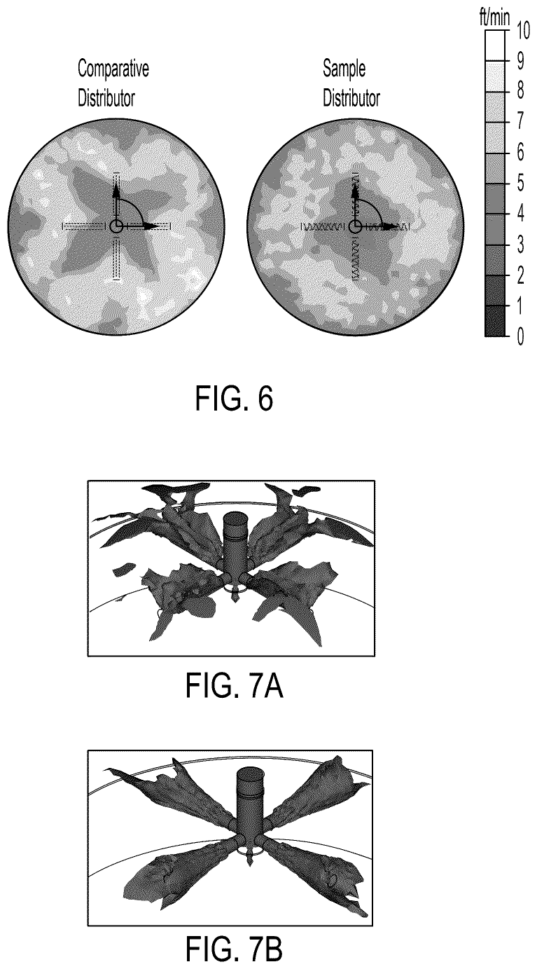

A flow rate of 1,000 gpm was used, and the fluid particle bed velocity in the adsorber and the fluid distribution were measured through the distributors. FIG. 6 depicts the results of the fluid particle bed velocity simulation. The comparative distributor had a wide range of fluid particle bed velocity with a minimum velocity of about 3 fpm and a maximum velocity of about 10 fpm. Additionally, the fluid particle bed velocity in the comparative example had an uneven fluid particle bed velocity throughout the sorbent vessel. The sample distributor had a lower range of fluid particle bed velocity with a minimum velocity of about 2 and a maximum velocity of about 7 fpm. Furthermore, the sample distributor had a substantially even distribution of fluid particle bed velocity across the sorbent vessel. The more even distribution of the fluid particle bed velocity across the sorbent vessel provides a significant decrease in channeling in the sorbent vessel. This results in a balanced use of all sorbent material within the adsorber unit.

FIGS. 7A and 7B depict fluid flow distributions of the comparative distributor and the sample distributor, respectively. The comparative distributor has a poor fluid distribution through its arms, which is further highlighted as the fluid travels further from the center of the distributor. This results in a high pressure drop and high fluid velocity exiting the distributor. In comparison, the sample distributor provides a substantially even diffusion of fluid in each direction through each of the arms. Furthermore, the sample distributor has a lower fluid velocity and pressure drop as the fluid travels farther from the distributor as compared to the comparative example. This provides the benefit of a decreased energy requirement in the fluid distribution and a more uniform use of the sorbent material within the sorbent vessel.

### Example 2: Fluid Velocity Ratio Testing

Computational fluid dynamics (CFD) software was used to simulate the fluid flow velocity of water through a comparative conventional distributor and a sample distributor comprising holes arranged in a spiral pattern in a sorbent vessel. The sample distributor had a spiral arrangement of 62 holes while the conventional sample had a linear arrangement of 51 holes. The testing for the sample distributor was performed at flow rates of 500 gpm, 750 gpm, 850 gpm, 1100 gpm, and 1200 gpm at an outlet area of 0.76 ft². The testing for the conventional distributor was performed at flow rates of 1000 gpm and 1100 gpm at an outlet area of 0.28 ft². The maximum velocity and the minimum velocity in feet per minute (fpm) within the adsorber was recorded and a velocity ratio was calculated using Equation 2. The results of the testing are provided below in TABLE 1.

TABLE 1

| | | Maximum | Minimum | | |
|---|---|---|---|---|---|
| | Flow Rate | Velocity | Velocity | Outlet Area | Velocity |
| Sample | (gal/min) | (ft./min) | (ft./min) | (ft²) | Ratio (ft⁻²) |
| 62 Hole | 500 | 4.1 | 1 | 0.76 | 5.39 |
| Spiral | | | | | |
| 62 Hole | 750 | 6.05 | 1.92 | 0.76 | 4.14 |
| Spiral | | | | | |
| 62 Hole | 850 | 6.79 | 1.97 | 0.76 | 4.53 |
| Spiral | | | | | |
| 62 Hole | 1100 | 8.97 | 2.49 | 0.76 | 4.73 |
| Spiral | | | | | |
| 62 Hole | 1200 | 10.35 | 2.96 | 0.76 | 4.6 |
| Spiral | | | | | |
| 51 Hole | 1000 | 10.1 | 2.92 | 0.28 | 12.43 |
| Straight | | | | | |
| 51 Hole | 1100 | 9.92 | 2.7 | 0.28 | 13.21 |
| Straight | | | | | |

At all measured flow rates, the sample distributor had a significantly lower velocity ratio than the conventional distributor. This shows that the sample distributor has a more uniform velocity distribution and sorbent material utilization than the conventional distributor.

### Example 3: Flow Rate and Pressure Drop Testing

Computational fluid dynamics (CFD) software was used to simulate the flow rate and pressure drop of water through a comparative conventional distributor and a sample distributor comprising holes arranged in a spiral pattern in a sorbent vessel. The sample distributor had a spiral arrangement of 62 holes while the conventional sample had a linear arrangement of 51 holes. Testing was performed on each of the distributors at flow rates of 100 gpm to 1700 gpm and a pressure drop and flow rate ratio was calculated using Equation 1. The results of the testing on the sample distributor are provided below in TABLE 2 and the results of the testing on the conventional distributor are provided below in TABLE 3.

TABLE 3

| Flow Rate (gal/min) | Pressure Drop (lbs./in.²) | Ratio (sqrt(psi)/gpm)) |
|---|---|---|
| 100 | 0.0034 | 5.85 |
| 200 | 0.0134 | 5.78 |
| 300 | 0.0298 | 5.75 |
| 400 | 0.0526 | 5.73 |
| 500 | 0.0818 | 5.72 |
| 600 | 0.1174 | 5.71 |
| 700 | 0.1595 | 5.70 |
| 800 | 0.2078 | 5.70 |
| 900 | 0.2626 | 5.69 |
| 1000 | 0.3238 | 5.69 |
| 1100 | 0.3913 | 5.69 |
| 1200 | 0.4652 | 5.68 |
| 1300 | 0.5455 | 5.68 |
| 1400 | 0.6321 | 5.68 |
| 1500 | 0.7251 | 5.68 |
| 1600 | 0.8245 | 5.68 |
| 1700 | 0.9302 | 5.67 |
| 100 | 0.0090 | 9.48 |
| 200 | 0.0356 | 9.44 |
| 300 | 0.0799 | 9.42 |
| 400 | 0.1417 | 9.41 |
| 500 | 0.2211 | 9.40 |
| 600 | 0.3179 | 9.40 |
| 700 | 0.4324 | 9.39 |
| 800 | 0.5643 | 9.39 |
| 900 | 0.7137 | 9.39 |
| 1000 | 0.8807 | 9.38 |
| 1100 | 1.0652 | 9.38 |
| 1200 | 1.2672 | 9.38 |
| 1300 | 1.4867 | 9.38 |
| 1400 | 1.7237 | 9.38 |
| 1500 | 1.9782 | 9.38 |
| 1600 | 2.2502 | 9.38 |
| 1700 | 2.5397 | 9.37 |

At all measured flow rates, the sample distributor had a significantly lower pressure drop ratio than the conventional distributor. This shows that the sample distributor has a more efficient energy usage than the conventional distributor.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A distributor for a sorbent vessel, the distributor comprising:
a main pipe configured to supply a fluid to the distributor; and
a plurality of arms operably connected to the main pipe and configured to supply the fluid to the sorbent vessel,
wherein each of the plurality of arms includes a series of holes arranged in a spiral pattern.

2. The distributor of claim 1, wherein the distributor has a pressure drop measured from the main pipe to the plurality of arms of about 0.25 psi to about 0.40 psi at a flow rate of 1000 gallons per minute.

3. The distributor of claim 1, wherein the distributor has a pressure drop measured from the main pipe to the plurality of arms of about 0.30 psi to about 0.35 psi at a flow rate of 1000 gallons per minute.

4. The distributor of claim 1, wherein each of the holes is substantially the same size.

5. The distributor of claim 1, wherein the holes increase in diameter along a length of each of the plurality of arms.

6. The distributor of claim 1, wherein the holes decrease in diameter along a length of each of the plurality of arms.

7. The distributor of claim 1, wherein each of the holes has a diameter of about 0.1 inches to about 2 inches.

8. The distributor of claim 1, wherein each of the holes has a diameter of about 0.5 inches to about 1 inch.

9. The distributor of claim 1, wherein each of the holes arranged in a spiral pattern have a ratio of a spiral pitch to a hole size of about 2.0 to about 8.0.

10. The distributor of claim 1, wherein the plurality of arms comprises 2, 3, 4, 5, 6, 7, or 8 arms.

11. The distributor of claim 1, wherein a spiral pitch of the spiral pattern is substantially the same along a length of an arm.

12. The distributor of claim 1, wherein a spiral pitch of the spiral pattern increases along a length of an arm.

13. The distributor of claim 1, wherein a spiral pitch of the spiral pattern decreases along a length of an arm.

14. The distributor of claim 1, wherein the distributor has a pressure drop ratio of about 4.0 to about 8.0.

15. A method of filtering chemical compounds from a fluid, the method comprising:
providing a sorbent vessel having a sorbent material within the sorbent vessel;
providing a distributor having a main pipe configured to supply a fluid to the distributor and having a plurality of arms operably connected to the main pipe and configured to supply the fluid to the sorbent vessel, and
distributing the fluid to the sorbent vessel using the distributor,
wherein each of the plurality of arms includes a series of holes arranged in a spiral pattern.

16. The method of claim 15, wherein the distributor has a pressure drop measured from the main pipe to the plurality of arms of about 0.25 psi to about 0.40 psi at a flow rate of 1000 gallons per minute.

17. The method of claim 15, wherein the distributor has a pressure drop measured from the main pipe to the plurality of arms of about 0.30 psi to about 0.35 psi at a flow rate of 1000 gallons per minute.

18. The method of claim 15, wherein each of the holes is substantially the same size.

19. The method of claim 15, wherein the holes increase in diameter along a length of each of the plurality of arms.

20. The method of claim 15, wherein the holes decrease in diameter along a length of each of the plurality of arms.

21. The method of claim 15, wherein each of the holes has a diameter of about 0.1 inches to about 2 inches.

22. The method of claim 15, wherein each of the holes has a diameter of about 0.5 inches to about 1 inch.

23. The method of claim 15, wherein each of the holes arranged in a spiral pattern have a ratio of a spiral pitch to a hole size of about 2.0 to about 8.0.

24. The method of claim 15, wherein the plurality of arms comprises 2, 3, 4, 5, 6, 7, or 8 arms.

25. The method of claim 15, wherein a spiral pitch of the spiral pattern is substantially the same along a length of an arm.

26. The method of claim 15, wherein a spiral pitch of the spiral pattern increases along a length of an arm.

27. The method of claim 15, wherein a spiral pitch of the spiral pattern decreases along a length of an arm.

28. The method of claim 15, wherein the fluid is distributed at a velocity ratio of about 2.0 to about 8.0.
